(19) United States
(12) Patent Application Publication
(10) Pub. No.: US 2024/0144826 A1
(43) Pub. Date: May 2, 2024

(54) BEACON-BASED INTERNET OF THINGS SYSTEM

(71) Applicant: Uspace Tech Ltd., Taipei City (TW)

(72) Inventor: Yen-Chieh Cheng, Taipei City (TW)

(73) Assignee: Uspace Tech Ltd., Taipei City (TW)

(21) Appl. No.: 18/098,085

(22) Filed: Jan. 17, 2023

(30) Foreign Application Priority Data
Nov. 1, 2022 (TW) 111141693

(51) Int. Cl. G08G 1/14; G07C 9/20

(52) U.S. Cl. CPC G08G 1/149; G07C 9/20

(57) ABSTRACT

The present invention reveals a beacon-based Internet of Things system comprising: a plurality of IoT devices, a plurality of gateways, and a backend server. According to the design of the present invention, each of the IoT devices is connected to one of the gateways that periodically broadcasts a stronger beacon signal and the backend server is connected to each of the gateways through the Internet Protocol. Consequently, the status information of each of the IoT devices is transmitted between each of the IoT devices and the backend server. With the beacon-based IoT system of the present invention, a more efficient, faster and more power-saving IoT system can be established.

### BACKGROUND OF THE INVENTION

### Field of the Invention

The invention relates to the technical field of Internet of Things (IoT) and more particularly, to a beacon-based IoT system.

### Description of the Prior Art

In recent years, along with innovation and evolution of overall technology, devices and objects are no longer limited to personal mobile communication devices or computer apparatuses for connecting to the Internet to return sensed data or interact with application service platforms by way of various communication technologies. Therefore, more and more objects and devices are capable of connecting to the Internet, thereby forming so-call Internet of Things (IoT). A variety of industrial applications and innovations, such as artificial intelligence (AI), big data collection and analysis and block chains, can be implemented by utilizing the IoT technology. Wide applications and services of the IoT technology can be seen everywhere, from smart homes, smart transportation, smart cities, smart factories, environmental monitoring, health care to smart agriculture, etc.

However, as the number of IoT devices increases, a stable and reliable communication architecture is apparent to be more important, such that information on the IoT devices can be accurately transmitted over a communication network, thereby refining various application services applying the IoT technology. If an IoT device fails to connect to the Internet stably and reliably, even the best IoT application service is provided, predetermined advanced and convenient application services still cannot be implemented in the absence of the accurate information provided by the IoT devices. That is, for providing good IoT application services, a reliable and stable network communication environment is one of the essential requirements. Thus, in order for an IoT device to accurately return information thereof, there are many issues related to the Internet to be considered, for example, the strength and coverage of wireless signals, limitations on communication bandwidths and so on.

Additionally, with rapid development of the IoT devices, the cost and power consumption have also become an obstacle against developing the IoT services. In light of this, for solving the aforementioned cost and power-saving issues, as well as for providing reliable and stable communication networks for good IoT application services, the inventor(s) of the application has made effort in researching and inventing and eventually, has developed and completed the beacon-based Internet of Things (IoT) system of the application.

### SUMMARY OF THE INVENTION

The main objective of the invention is to provide a beacon-based Internet of Things (IoT) system, which mainly comprises: a plurality of IoT devices, a plurality of gateways and a backend server. According to the design of the invention, the aforementioned IoT devices refer to those utilizing a beacon technology to establish connections for communication with the gateways by way of a low-power wide-area network (LPWAN), while the backend server establishes connections for communication with the gateways through an Internet protocol, thereby transmitting status information of each of the IoT devices between each of the IoT devices and the backend server.

In order to achieve the objective, the invention provides an embodiment of a beacon-based IoT system, which comprises:
a plurality of IoT devices, each of the IoT devices having a first communication module and a driving module, wherein the driving module is configured to drive an operation of the corresponding IoT device, and the first communication module is electrically connected with the driving module;
a plurality of gateways, each of the gateways having a second communication module and a third communication module, wherein the second communication module is connected for communication with the first communication module and the third communication module; and a backend server, having a fourth communication module, wherein the fourth communication module is connected for communication with the third communication module of each of the gateways;
wherein each of the gateways periodically broadcasts a beacon signal through the second communication module to establish a connection for communication with the first communication module of one or more of the IoT devices, and the third communication module of each of the gateways establishes a connection for communication with the fourth communication module of the backend server, thereby transmitting status information of each of the IoT devices between each of the IoT devices and the backend server.

In an embodiment, the third communication module of each of the gateways is connected for communication with the fourth communication module of the backend server through an Internet protocol in a wireless or wired manner.

In an embodiment, the first communication module of each of the IoT devices scans (first scans) the beacon signal broadcasted by the second communication module of each of the gateways and is connected for communication with the second communication module of one of the gateways that broadcasts a stronger beacon signal.

In an embodiment, after the first communication module of each of the IoT devices is connected for communication with the second communication module of the gateway that broadcasts the stronger beacon signal, the second communication module transmits the status information of the IoT device received from the first communication module to the backend server through the third communication module of the gateway and the fourth communication module of the backend server.

In an embodiment, after the status information of the IoT device is received by the backend server, the backend server transmits information of a gateway near the IoT device to the IoT device sequentially through the fourth communication module, the third communication module, the second communication module and the first communication module, wherein the contents of the information of the gateway comprise geo-information and signal quality information of the gateway near the IoT device.

In an embodiment, if the information of the gateway does not comprise the geo-information and signal quality information of the gateway near the IoT device, the IoT device keeps being connected for communication with the second communication module of the gateway that broadcasts the stronger beacon signal, if the information of the gateway comprises the geo-information and signal quality information of one or more of the gateways near the IoT device, the first communication module of the IoT devices again scans (scans a second time) the beacon signal broadcasted by the second communication module of one or more of the gateways near the IoT device and is connected for communication with the second communication module of another one of the gateways that broadcasts the stronger beacon signal which is again scanned, and if there is no other one of the gateways that broadcasts the stronger beacon signal is found after the scanning is again performed, the IoT device keeps being connected for communication with the second communication module of the gateway that broadcasts the stronger beacon signal.

In an embodiment, the IoT device is a parking barrier, and the driving module is configured to drive the parking barrier to be locked or unlocked. Additionally, the status information of each of the parking barriers transmitted between each of the parking barriers and the backend server is the status information related to whether the parking barrier is locked or unlocked.

In an embodiment, the IoT device is an electric vehicle charging pile, an industrial robot, a smart parking bollard or a smart-home appliance.

### BRIEF DESCRIPTION OF DRAWINGS

The invention as well as a preferred mode of use and advantages thereof will be best understood by referring to the following detailed description of an illustrative embodiment in conjunction with the accompanying drawings, wherein:

FIG. 1A and FIG. 1B are schematic diagrams showing a beacon-based IoT system of an embodiment of the invention;

FIG. 2A and FIG. 2B are schematic diagrams showing the application of a beacon-based IoT system of an embodiment of the invention;

FIG. 3 is a block diagram showing the beacon-based IoT system of an embodiment of the invention;

FIG. 4 is a block diagram showing a beacon-based IoT system according to another embodiment of the invention;

FIG. 5 is a flowchart of a communication method of the beacon-based IoT system of an embodiment of the invention;

FIG. 6 is a schematic diagram showing the gateway of the beacon-based IoT system that broadcasts a beacon signal of an embodiment of the invention; and

FIG. 7 is a schematic diagram showing the gateway of the beacon-based IoT system that broadcasts a beacon signal according to another embodiment of the invention.

### DETAILED DESCRIPTION OF THE PREFERRED EMBODIMENTS

In order to more clearly describe a beacon-based Internet of Things (IoT) system 100 proposed by the invention, preferred embodiments are provided and described with reference to the accompanying drawings hereinafter.

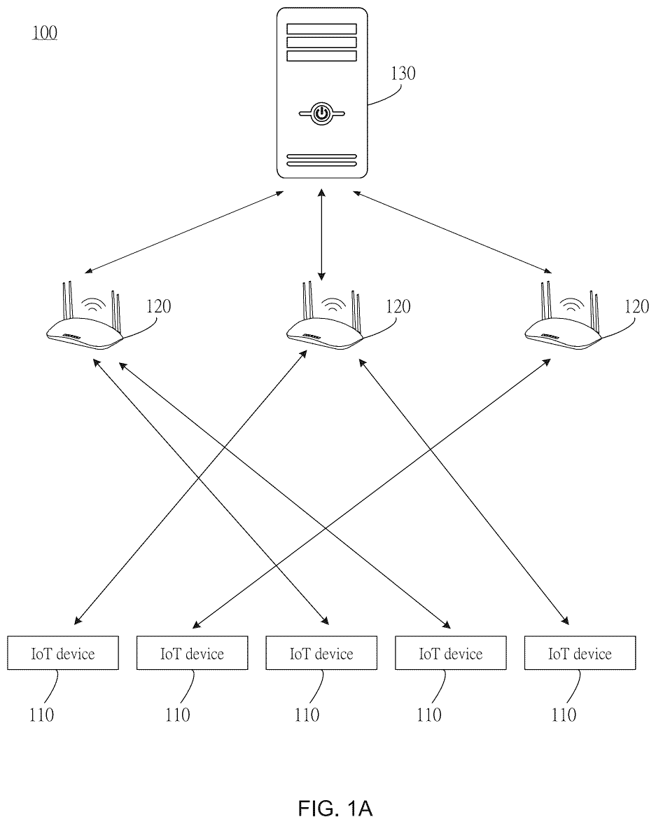

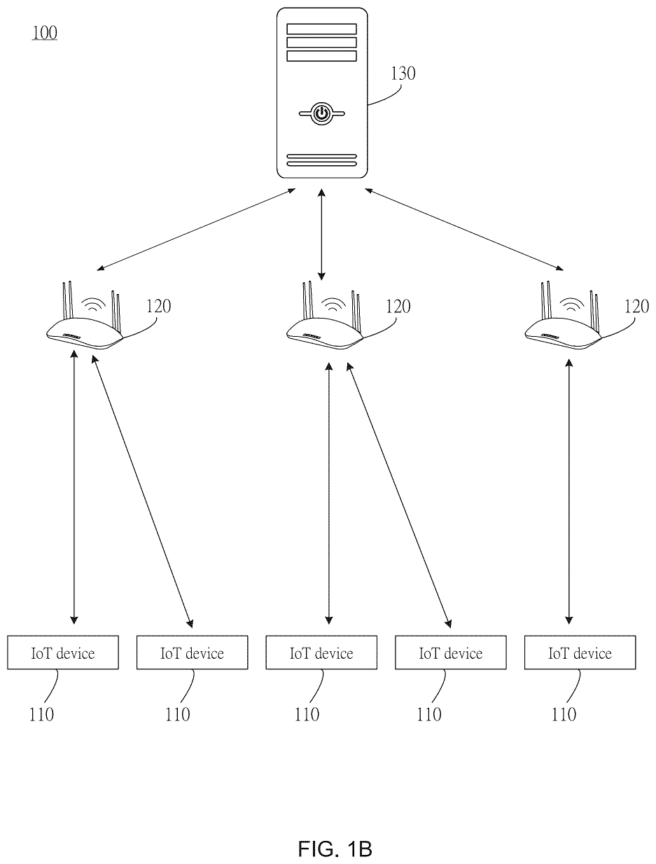

Referring to FIG. 1A and FIG. 1B, schematic diagrams of a beacon-based IoT system 100 of an embodiment of the invention are illustrated. As illustrated in the figures, the present embodiment is a beacon-based IoT system 100, which comprises a plurality of IoT devices 110, a plurality of gateways 120 and a backend server 130, wherein each of the IoT devices 110 selects a gateway that is closest in distance thereto and/or provides a signal with stronger received signal strength indication (RSSI), for example, the gateway 120 with a stronger beacon signal 120S, to establish a connection for communication. Therefore, the connection status between each of the IoT devices 110 and each of the gateways 120 changes from FIG. 1A to FIG. 1B, where such connection method for establishing communication is more efficient, faster and more power-saving. Additionally, the gateways 120 also establish connections for communication with the backend server 130, thereby transmitting status information of each of the IoT devices 110 between each of the IoT devices 110 and the backend server 130.

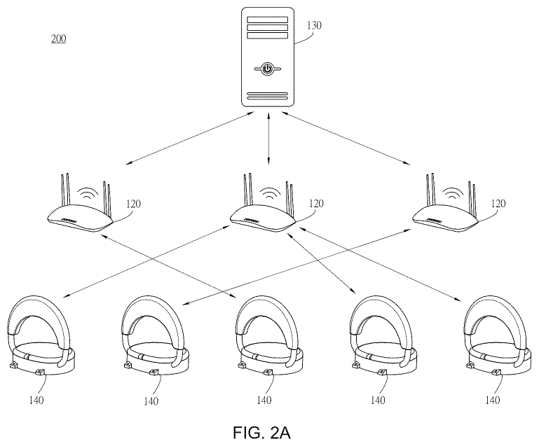

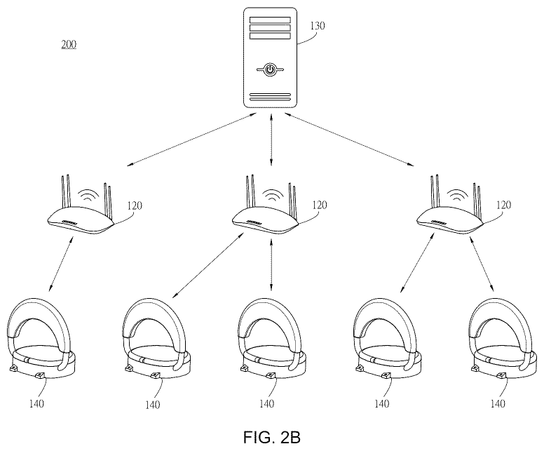

Further, referring to FIG. 2A and FIG. 2B, as illustrated in the figures, the present embodiment is a beacon-based IoT system 200, which comprises a plurality of parking barriers 140, the plurality of gateways 120 and the backend server 130, wherein each of the parking barriers 140 selects a gateway 120 that is closest in distance thereto and/or provides the strongest wireless signal (e.g., the beacon signal 120S) to establish a connection for communication. Therefore, the connection status between each of the parking barriers 140 and each of the gateways 120 changes from FIG. 2A to FIG. 2B, where such connection method for establishing the connection for communication makes the management and control of parking spaces and parking barriers more efficient, faster and more power-saving. Additionally, the gateways 120 also establish connections for communication with the backend server 130, thereby transmitting status information of each of the parking barriers 140 between each of the parking barriers 140 and the backend server 130. The status information of the parking barrier 140 refers to the parking barrier 140 provided with a sensor (for example, an ultrasonic sensor) which is configured to sense a distance between the parking barrier 140 and a vehicle, thereby, determining whether a parking space is occupied and determining whether the parking barrier is in a locked or unlocked status. Additionally, the sensor may also be an mmWave radar sensor, a geomagnetic sensor or an ambient light sensor configured to sense whether a parking space is occupied.

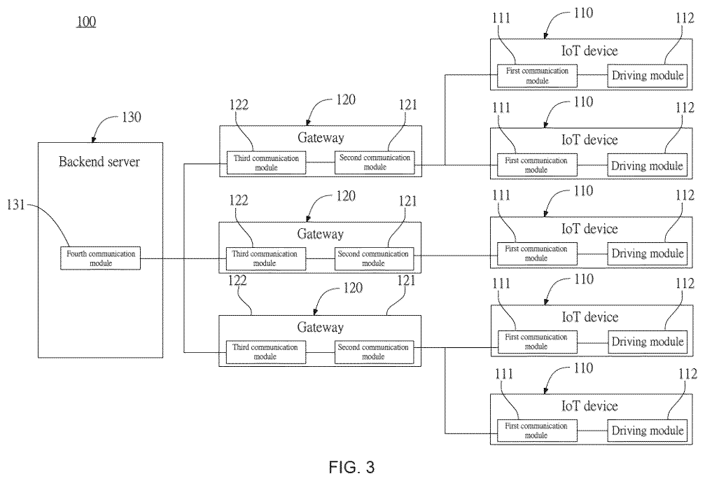

Referring to FIG. 3, a schematic diagram of the beacon-based IoT system 100 of an embodiment of the invention is illustrated, which comprises:
a plurality of IoT devices 110, each of the IoT devices 110 having a first communication module 111 and a driving module 112, wherein the driving module 112 is configured to drive an operation of the corresponding IoT device 110, and the first communication module 111 is electrically connected with the driving module 112;
a plurality of gateways 120, each of the gateways 120 having a second communication module 121 and a third communication module 122, wherein the second communication module 121 is connected for communication with the first communication module 111 and the third communication module 122; and
a backend server 130, having a fourth communication module 131, wherein the fourth communication module 131 is connected in communication with the third communication module 122 of each of the gateways 120;
wherein the gateway 120 establishes a connection for communication with one or more of the corresponding IoT devices 110 through the second communication module 121 and one or more of the first communication modules 111, and the gateway 120 establishes a connection for communication with the backend server 130 through the third communication module 122 and the fourth communication module 131, thereby transmitting status information of each of the IoT devices 110 between each of the IoT devices 110 and the backend server 130.

Additionally, in the aforementioned embodiments, the first communication module 111 and the second communication module 121 are wireless-protocol communication modules. That is, the first communication module 111 and the second communication module 121 establish the connections for wireless communication through the wireless-protocol communication module via a known protocol, for example, WiFi, Bluetooth, LoRa or ZigBee. Further, in the invention, a beacon technology for a broadcast protocol which is established based on a low power consumption wireless network protocol is used to establish the connection for communication between the first communication module 111 and the second communication module 121. Moreover, the beacon technology has advantages, such as low cost, low power consumption and sufficiently long standby time.

Further in the aforementioned embodiments, the third communication modules 122 and the fourth communication module 131 are Ethernet modules or wireless wide area communication modules. In this way, the backend server 130 and the plurality of gateways 120 may establish connections for communication through the third communication modules 122 and the fourth communication module 131 in a wired or wireless manner. In addition, the third communication modules 122 and the fourth communication module 131 may also include other network modules implementing Internet protocols, such as 4G communication modules, 5G communication modules, 6G communication modules or WiMAX communication modules.

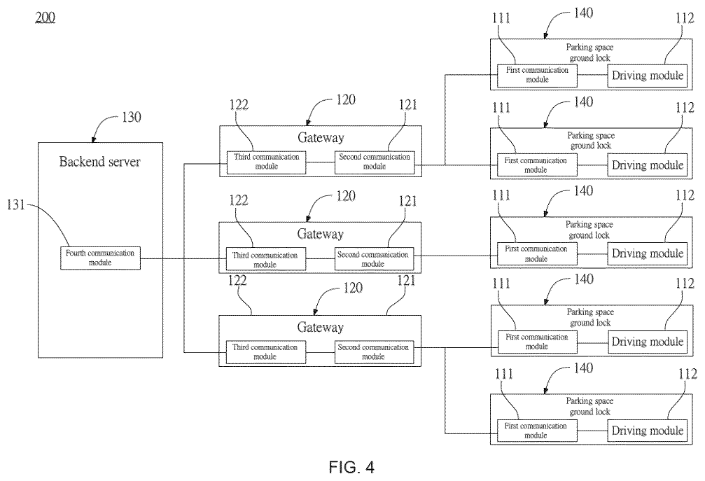

Further referring to FIG. 4, as illustrated in the figure, a schematic diagram of the beacon-based IoT system 200 according to another embodiment of the invention is illustrated. Differing from the aforementioned embodiments, the IoT device 110 is a parking barrier 140. The gateway 140 establishes a connection for communication with the gateway 120 through the first communication module 111 and the second communication module 121, and the gateway 120 establishes a connection for wireless or wired communication with the backend server 130 through the third communication module 122 and the fourth communication module 131, thereby transmitting status information each parking barrier 140 between each parking barrier 140 and the backend server 130. Additionally, each first communication module 111 establishes a connection for communication with the second communication module 121 of one of the gateways 121 that broadcasts a stronger beacon signal 120S.

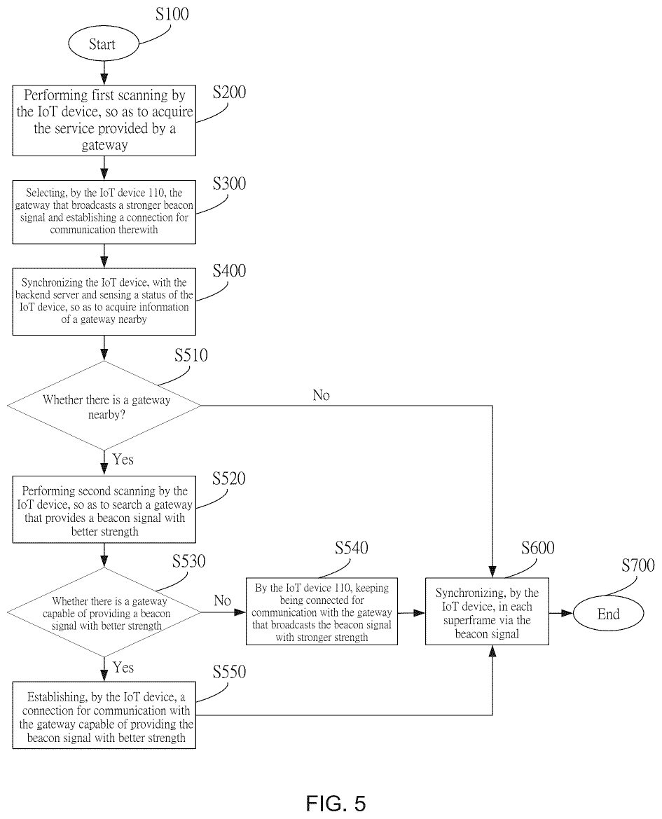

Further referring to FIG. 5, as illustrated in the figure, a flowchart of a communication method of the beacon-based IoT system 100 of an embodiment of the invention is illustrated. In step S100, the beacon-based IoT system 100 starts to operate. In step S200, the first communication module 111 of the IoT device 110 performs first scanning to scan the beacon signal 120S broadcasted by the second communication module 121 of each gateway 120 with a specific period, so as to obtain the service provided by one of the plurality of gateways 120. In step S300, the IoT device 110 selects the second communication module 121 of one of the gateways 120 that broadcasts the stronger beacon signal to establish a connection for communication therewith. In step S400, the IoT device 110 senses its status information by a sensor and then, through the connection for communication established in step S300, synchronizes the status information with the backend server 130 through the third communication module 122 of the gateway 120 and the fourth communication module 131 of the backend server 130. And, the IoT device 110 obtains information of a gateway near the IoT device 110 from the backend server 130, wherein the information of the gateway refers to geo-information and signal quality information of the gateway 120 near the IoT device 110. In step S510, if the information of the gateway does not comprise the geo-information and signal quality information of the gateway 120 near the IoT device 110, the IoT device 110 keeps being connected for communication with the second communication module 121 of the gateway 120 that broadcasts the stronger beacon signal 120S which is first scanned. And in step S600, the IoT device 110, in each superframe periodically broadcasted by the second communication module 121 of the gateway 110, is synchronized with the backend server 130 via the gateway 120 through the beacon signal 120S. Finally, the operation ends in step S700. In step S510, if the information of the gateway 110 comprises the geo-information and signal quality information of one or more of the gateways 120 near the IoT device 110, in step S520, the first communication module 111 of the IoT device 110 performs second scanning to scan the beacon signal 120S broadcasted by the second communication module 121 of one or more of the IoT devices 110, so as to select a gateway 120 that provides the beacon signal 120S with better strength. In step S530, whether there is a gateway 120 capable of providing the beacon signal 120S with better strength than that in first scanning is determined. If there is no other one of the gateways that broadcasts the beacon signal 120S with stronger strength, in step S540, the IoT device 110 keeps being connected for communication with the second communication module 121 of the gateway 120 that broadcasts the beacon signal with stronger strength that is obtained in the first scanning. Further, in step S600, the IoT device 110, in each superframe periodically broadcasted by the second communication module 121 of the gateway 110, is synchronized with the backend server 130 via the gateway 120 through the beacon signal 120S. Finally, the operation ends in step S700. In step S530, if it is determined that the gateway 120 capable of providing the beacon signal 120S with better strength is found in second scanning, in step S550, the IoT device 110 is connected for communication with the second communication module 121 of another gateway 120 that broadcasts the beacon signal with stronger strength in the second scanning, and in step S600, the IoT device 110, in each superframe periodically broadcasted by the second communication module 121 of another gateway 120 that broadcasts the beacon signal with stronger strength, is synchronized with the backend server 130 via the gateway 120 through the beacon signal 120S. Finally, the operation ends in step S700.

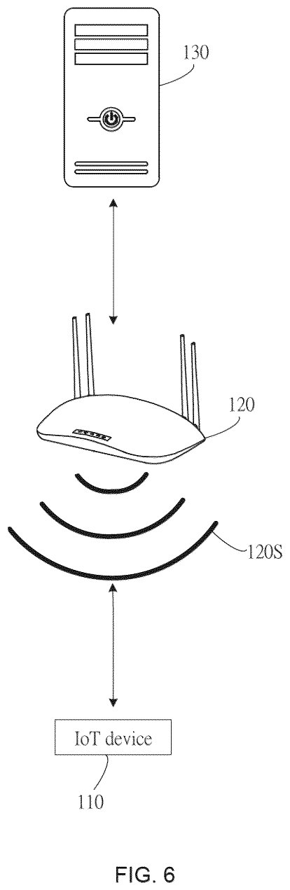

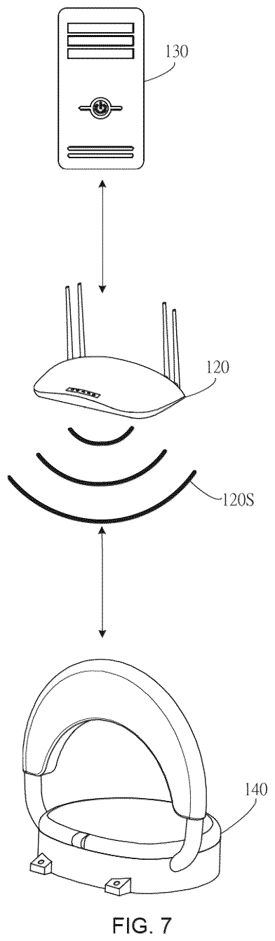

FIG. 6 and FIG. 7 are schematic diagrams showing the gateways of the beacon-based IoT system that broadcast the beacon signal 120S of the embodiment of the invention, wherein the gateway 120 periodically broadcasts the beacon signal 120S, and the IoT device 110 or the parking barrier 140 scans the beacon signal 120S and establishes a connection for communication with the gateway 120 via the beacon signal 120S.

The beacon-based IoT system 100 of the invention has been comprehensively and clearly described in the above. It is to be emphasized that the feasible embodiments of the invention have been specifically described above, though the embodiments are not intent to limit the scope of the invention; however, any equivalent implementation or modification without departing from the technical spirit of the invention shall all fall within the scope of the claims of the invention.

What is claimed is:

1. A beacon-based Internet of Things (IoT) system, comprising:
a plurality of IoT devices, each of the IoT devices having a first communication module and a driving module, wherein the driving module is configured to drive an operation of the corresponding IoT device, and the first communication module is electrically connected with the driving module;
a plurality of gateways, each of the gateways having a second communication module and a third communication module, wherein the second communication module is connected for communication with the first communication module and the third communication module; and
a backend server, having a fourth communication module, wherein the fourth communication module is connected for communication with the third communication module of each of the gateways;
wherein each of the gateways periodically broadcasts a beacon signal through the second communication module to establish a connection for communication with the first communication module of one or more of the IoT devices, and the third communication module of each of the gateways establishes a connection for communication with the fourth communication module of the backend server, thereby transmitting status information of each of the IoT devices between each of the IoT devices and the backend server.

2. The IoT system according to claim 1, wherein the third communication module of each of the gateways is connected for communication with the fourth communication module of the backend server through an Internet protocol in a wireless or wired manner.

3. The IoT system according to claim 1, wherein the first communication module of each of the IoT devices scans the beacon signal broadcasted by the second communication module of each of the gateways and is connected for communication with the second communication module of one of the gateways that broadcasts a stronger beacon signal.

4. The IoT system according to claim 3, wherein after the first communication module of each of the IoT devices is connected for communication with the second communication module of the gateway that broadcasts the stronger beacon signal, the second communication module transmits the status information of the IoT device received from the first communication module to the backend server through the third communication module of the gateway and the fourth communication module of the backend server.

5. The IoT system according to claim 4, wherein after the status information of the IoT device is received by the backend server, the backend server transmits information of a gateway near the IoT device to the IoT device sequentially through the fourth communication module, the third communication module, the second communication module and the first communication module, wherein the information of the gateway comprises geo-information and signal quality information of the gateway near the IoT device.

6. The IoT system according to claim 5, wherein if the information of the gateway does not comprise the geo-information and signal quality information of the gateway near the IoT device, the IoT device keeps being connected for communication with the second communication module of the gateway that broadcasts the stronger beacon signal, if the information of the gateway comprises the geo-information and signal quality information of one or more of the gateways near the IoT device, the first communication module of the IoT device again scans the beacon signal broadcasted by the second communication module of the one or more of the gateways near the IoT device and is connected for communication with the second communication module of another one of the gateways that broadcasts the stronger beacon signal which is again scanned, and if there is no other one of the gateways that broadcasts the stronger beacon signal is found after the scanning is again performed, the IoT device keeps being connected for communication with the second communication module of the gateway that broadcasts the stronger beacon signal.

7. The IoT system according to claim 6, wherein the IoT device is a parking barrier.

8. The IoT system according to claim 7, wherein the driving module is configured to drive the parking barrier to be locked or unlocked.

9. The IoT system according to claim 8, wherein the status information is the information related to whether the parking barrier is locked or unlocked.

10. The IoT system according to claim 6, wherein the IoT device is an electric vehicle charging pile, an industrial robot, a smart parking bollard or a smart-home appliance.
